(19) United States
(12) Patent Application Publication
(10) Pub. No.: US 2014/0248578 A1
(43) Pub. Date: Sep. 4, 2014

(54) Dispensing Container for Dental Compound

(71) Applicants: Joachim Fritze, Preetz (DE); Heinrich Spreizer, Ermatingen (CH)

(72) Inventors: Joachim Fritze, Preetz (DE); Heinrich Spreizer, Ermatingen (CH)

(73) Assignee: Transcodent GmbH & Co. KG, Kiel (DE)

(21) Appl. No.: 14/111,743

(22) PCT Filed: Apr. 12, 2012
(86) PCT No.: PCT/EP12/56714

§ 371 Date: Apr. 24, 2014

(30) Foreign Application Priority Data
Apr. 15, 2011 (DE) 10 2011 017 076.6

(51) Int. Cl. A61C 5/04; A61C 19/02

(52) U.S. Cl. CPC A61C 5/04; A61C 19/02
USPC 433/89

(57) ABSTRACT

The invention relates to a dispensing container for a dental compound. The dispensing container comprises a chamber (15), a discharge tip (16) and a channel (17), which extends from the chamber (15) as far as a channel opening (18) arranged at the front end of the discharge tip (16). The discharge tip (16) has a jacket surface (23) tapering towards the front end. A cap (20) is provided which has an inner surface adapted to the jacket surface (23) of the discharge tip (16). According to the invention, the inner surface of the cap (20) has a plurality of guide webs (24). The invention also relates to a cap for a dispensing container of this kind. The dispensing container according to the invention reduces the likelihood of the dental compound being contaminated by particles.

### FIELD OF THE DISCLOSURE

The invention relates to a dispensing container, by way of which dental compound can be dispensed out of a chamber. The dispensing container comprises a chamber, an application tip and a channel which extends from the chamber as far as the front end of the application tip. The application tip has a circumferential face which tapers toward a front end. A cap is provided for the application tip, which cap has an inner face which is adapted to the circumferential face of the application tip. Moreover, the invention relates to a cap for a dispensing container of this type.

### BACKGROUND

The dental compound which the dentist uses during the tooth treatment is contained in the chamber of the dispensing container. If pressure is exerted on the dental compound in the chamber, the dental compound exits through the channel at the front end of the application tip and can be processed by the dentist.

The dental compound which is contained in the chamber is not used up during a single treatment, but rather is sufficient for multiple usage. The dispensing container is closed by way of the cap between two usages. To this end, the cap is plugged onto the application tip, with the result that the channel opening of the channel is closed at the front end of the application tip.

When the cap is plugged onto the application tip, contact between the application tip and the inner face of the cap occurs as a rule. The application tip is guided along the inner face of the cap, as a result of which the application tip is centered in the cap. This centering action is advantageous both when the cap is plugged on manually and when the cap is closed by machine during the first closure of the dispensing container.

In previous dispensing containers, the cap has an inner face which is shaped in such a way that it rests flatly on the application tip over the entire circumference of the circumferential face. If the convex outer face of the application tip is guided along on the concave inner face of the cap, particles can be abraded from the surface as a result of the friction. During further plugging on, the particles are conducted to the front by way of the application tip and pass into the region of the channel opening. There is the risk of the dental compound in the region of the channel opening being mixed with the particles. If dental compound which is contaminated with particles which are removed by the cap is used on the patient, this can have disadvantageous consequences.

### SUMMARY

The invention is based on the object of proposing a dispensing container and a cap which is intended for a dispensing container of this type, in which the risk of contamination of the dental compound is reduced. Proceeding from the prior art which was stated at the outset, the object is achieved by way of the features of the independent claims. According to the invention, a plurality of guide webs are formed on the inner face of the cap. Advantageous embodiments are found in the subclaims.

First of all, some terms will be explained. The application tip defines a channel, into which the dental compound can enter from the chamber. At the opposite end, the channel has a channel opening, from which the dental compound can exit. The end, at which the channel opening is situated, is called the front end of the application tip. The end, at which the channel merges into the chamber, is called the rear end. The expressions front and rear are used correspondingly in the case of the cap.

The tapering circumferential face of the application tip can extend over the entire length of the application tip from the front end as far as the rear end. However, embodiments are also possible, in which only one section of the application tip which is adjacent to the front end has a tapering circumferential face. In the adjacent section, the circumferential face can have a different shape and can be, for example, cylindrical. The inner face of the cap can be designed in such a way that the frictional connection to the circumferential face is produced only in the tapering section. If, in alternative embodiments, the frictional connection also extends to an adjacent cylindrical section, this can improve the grip of the cap on the application tip.

The guide webs on the inner face of the cap form the regions, with which the cap rests on the outer face of the application tip in the closed state. There is a clearance in each case between two guide webs, in which clearance there is no contact between the application tip and the cap. This relates to the state, in which the cap is plugged onto the application tip. The cap can be pulled off from the application tip and is then present as a separate object.

If the application tip tapers toward the front end, this means that the application tip has a smaller diameter at the front end than at the rear end. The application tip preferably tapers conically, it being possible for the cone angle to lie, for example, between 2° and 8°.

The guide webs according to the invention achieve a situation where, during plugging of the cap onto the application tip, the first contact takes place between the circumferential face of the application tip and a guide web of the cap. During further plugging of the cap onto the application tip, the application tip is guided along the guide web. In some circumstances, particles are detached from the surface of the guide web or from the circumferential face of the application tip as a result of the friction. However, during further plugging on of the cap, said particles are not conducted into the region of the channel opening, but rather are displaced to the side into the clearances between the guide webs. The particles are not disruptive there, however, because they cannot be mixed with the dental compound. The risk of the dental compound being contaminated by particles is reduced.

On account of the clearances between the guide webs, there is no sealing closure between the circumferential face of the application tip and the inner face of the cap. A sealing closure is desired, however, in order that the dental compound is protected against environmental influences between two usages. The sealing closure is preferably produced via a front face of the application tip, which front face extends around the channel opening. If the front face is oriented at right angles with respect to the axis of the application tip, a sealing closure of the channel opening is produced in the case of any desired angular orientation of the cap which is plugged on. An end face which is adapted to the front face of the application tip can be provided in the interior of the cap. A conical projection which rises up in the direction of the channel opening can be formed on the end face for improved sealing of the channel opening.

In order to afford satisfactory guidance for the application tip, at least three guide webs are preferably provided. The guide webs can be distributed uniformly over the circumference of the cap. The guidance can optionally be improved by further guide webs. For example, four, five or six guide webs can be provided. The guide webs can have a longitudinal direction which is oriented parallel to the axis of the cap. This is equivalent to the guide webs being oriented parallel to the axis of the application tip in the plugged-on state of the cap. The guide webs preferably have a convex shape in the transverse direction. If the convex circumferential face of the application tip is guided along convex guide webs, particles are removed only to a small extent. The risk of contaminations of the dental compound is reduced further as a result. More preferably, the guide webs have a continuous curvature in the transverse direction and are free of edges.

The better the application tip is centered during plugging on of the cap, the further to the front the first contact takes place between the application tip and the inner face of the cap. In order that reliable guidance of the application tip in the cap takes place even when said application tip is centered poorly, the guide webs are to extend over a great length in the cap. The length of the guide webs is preferably greater than 50%, more preferably greater than 70%, more preferably greater than 80% of the length of the application tip.

On its outer side, the cap is preferably designed in such a way that the forces for plugging on and pulling off the cap can be transmitted easily. During plugging on of the cap, a force has to be applied predominantly in the axial direction. To this end, the cap preferably comprises a projection which protrudes to the outside, extends over the circumference of the cap and points toward the front end of the cap. The projection can be arranged in that half of the cap which is remote from the front end.

In order to pull off the cap, an axial force has to be exerted predominantly in the opposite direction. To this end, a projection which points toward the rear end of the cap can be provided. Said projection can likewise extend over the circumference of the cap. The projection which points toward the rear end is preferably closer to the rear end of the cap than the projection which points toward the front end.

During pulling off, the cap is occasionally stuck to such an extent that it cannot be readily pulled off in the axial direction. The releasing of the cap can be facilitated by the cap additionally being rotated relative to the application tip. To this end, ribs which extend in the longitudinal direction can be provided on the outer side of the cap. A torque can be exerted on the cap via the ribs. In order to improve the transmission of force, the ribs can have one or more edges.

It is advantageous if the operator can change between the exertion of a torque and the exertion of a force in the axial direction without changing the position of his/her fingers. In one advantageous embodiment, the ribs are therefore arranged in such a way that they extend from the rearwardly pointing projection in the direction of the rear end of the cap. For example, from 16 to 20 ribs of this type can be provided.

As an alternative or in addition, ribs can also be provided which extend from the forwardly pointing projection in the direction of the front end of the cap. Said ribs can impart additional grip when the operator acts on said region during plugging on of the cap. The ribs and projections are helpful, in particular, when the operator is wearing gloves.

Moreover, the invention relates to a cap which is intended for a dispensing container of this type. The cap has an inner face which is adapted to the circumferential face of the application tip. A plurality of guide webs are formed on the inner face. The cap can be combined with further features which have been described above in relation to the cap of the dispensing container.

The dispensing container serves to dispense small quantities of dental compound which are used during tooth treatment. The dimensions of the dispensing container and of the application tip correspond to said use. The chamber of the dispensing container preferably has a length between 10 mm and 30 mm. The diameter of the chamber can lie, for example, between 4 mm and 10 mm. The length of the cap between the front end and the rear end preferably lies between 5 mm and 10 mm. The greatest diameter transversely with respect thereto preferably lies between 4 mm and 8 mm. The length of the application tip preferably corresponds to the length of the cap.

### BRIEF DESCRIPTION OF THE DRAWINGS

In the following text, the invention will be described by way of example using advantageous embodiments with reference to the appended drawings, in which:

FIG. 1 shows a dispensing container according to the invention without cap,

FIG. 2 shows the dispensing container from FIG. 1 with cap,

FIG. 3 shows a side view of a cap according to the invention,

FIG. 4 shows a view from the rear of the cap from FIG. 3,

FIG. 5 shows another embodiment of a cap according to the invention in a perspective view, and

FIG. 6 shows the cap from FIG. 5 in another perspective.

### DETAILED DESCRIPTION OF PREFERRED EMBODIMENT

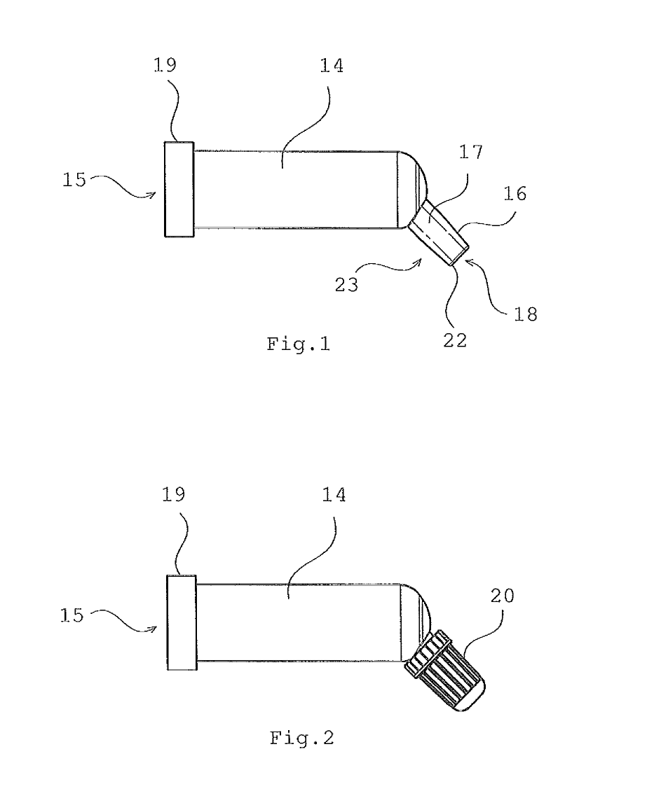

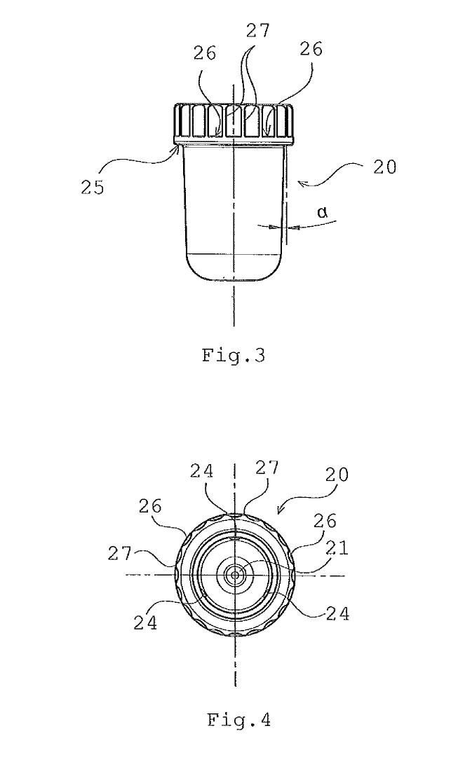

A dispensing container which is shown in FIG. 1 has a cylindrical housing 14 which encloses a cylindrical chamber 15. The chamber 15 is filled with a dental compound. The dental compound can be, for example, a substance which serves to fill cavities in teeth and which is hardened by UV radiation after being introduced into the cavity.

The front end of the housing 14 is adjoined by an application tip 16. A channel 17 which is indicated using dashed lines in FIG. 1 is formed in the interior of the application tip 16, which channel 17 extends from the chamber 15 as far as a channel opening 18 at the front end of the application tip 16. The application tip 16 has a conical circumferential face 23 which tapers toward the front end. The cone angle a of the circumferential face 23 is approximately 4°.

At its rear end, the chamber 15 is closed off by way of a plunger (not visible in FIG. 1) which is received slidingly in the chamber 15. The plunger is closed sealingly all the way round with the inner wall of the chamber, with the result that the dental compound which is contained in the chamber is insulated from the surroundings.

For use, the dispensing container according to the invention is connected via a flange 19 to a tool (not shown in the figures). The tool is designed in such a way that, upon actuation, a push rod emerges at the front end of the tool and presses the plunger of the dispensing container into the chamber 15. Under the pressure of the plunger, the dental compound moves through the channel 17 to the channel opening 18 and exits the dispensing container there. The dental compound is ready for further use by the dentist.

The chamber 15 has a length of approximately 20 mm and a diameter of approximately 5 mm. The quantity of dental compound which is contained in the chamber is not used up during a single usage, but rather is sufficient for a plurality of usages.

In the delivered state and between two usages, the channel opening 18 of the channel 17 is closed by way of a cap 20 which is plugged onto the application tip 16. The cap 20 has an inner end face 21 (shown in FIG. 4). The inner end face 21 terminates with the front face 22 of the application tip 16, which front face 22 extends around the channel opening 18. The dental compound which is situated in the region of the channel opening 18 is insulated against the surroundings as a result.

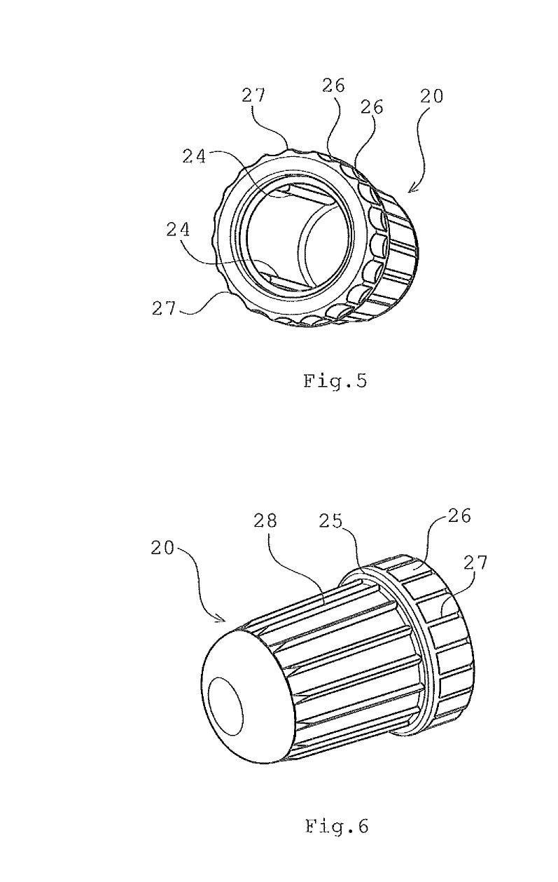

Three guide webs 24 (shown in FIGS. 4 and 5) which extend in the longitudinal direction of the cap 20 are formed on the inner face of the cap 20. The guide webs 24 are adapted to the conical circumferential face 23 of the application tip 16, that is to say the guide webs 24 taper toward the front end of the cap 20 at an angle of approximately 4°. In the transverse direction, the guide webs 24 rise up from the inner face of the cap 20 in a continuously curved shape which is free from edges. The guide webs rise up by from approximately 0.1 mm to 0.5 mm with respect to the inner face.

In the plugged-on state, there is a frictional connection between the guide webs 24 of the cap 20 and the circumferential face 23 of the application tip 16, by way of which frictional connection the cap 20 is held on the application tip 16.

On its circumferential face, the cap 20 has a projection 25 which points toward the front end and is arranged close to the rear end of the cap 20. The projection 25 affords resistance to the fingers of the operator when the cap 20 is plugged on. Moreover, the cap 20 has a rearwardly pointing projection 26 which is interrupted by ribs 27. The fingers of the operator experience resistance on the projection 26 when pulling off the cap 20. Via the ribs 27, of which twenty are distributed over the circumference of the cap, the cap 20 can be rotated somewhat in parallel, in order to facilitate the pulling off. The cap according to FIGS. 5 and 6 additionally has ribs 28 between the forwardly pointing projection 25 and the front end of the cap 20. The ribs 28 improve the handling during plugging on of the cap 20.

When the cap 20 is plugged onto the application tip 16, the first contact between the application tip 16 and the cap 20 takes place at one of the guide webs 24. Since both faces which come into contact with one another have a convex shape, particles are abraded from the surface only to a small extent. During further plugging on of the cap 20, the particles are displaced toward the side into the clearances between the guide webs 24, with the result that the dental compound which is situated in the region of the channel opening 18 is not contaminated by particles.

1. A dispensing container for a dental compound having a chamber, having an application tip and having a channel which extends from the chamber to a channel opening which is arranged at the front end of the application tip, the application tip having a circumferential face which tapers toward the front end, and a cap being provided which has an inner face which is adapted to the circumferential face of the application tip, wherein the inner face of the cap has a plurality of guide webs, and in that, in the plugged-on state, there is a frictional connection between the guide webs of the cap and the circumferential face of the application tip, by way of which frictional connection the cap is held on the application tip.

2. The dispensing container as claimed in claim 1, wherein the application tip has a front face which extends around the channel opening and is oriented at right angles with respect to the axis of the application tip.

3. The dispensing container as claimed in claim 2, wherein the cap has an inner end face which is adapted to the front face of the application tip.

4. The dispensing container as claimed in claim 1, wherein the guide webs have a longitudinal direction which is parallel with respect to the axis of the cap.

5. The dispensing container as claimed in claim 1, wherein the guide webs have a continuously curved shape in the transverse direction.

6. The dispensing container as claimed in claim 1, wherein the guide webs extend over at least 50%, preferably at least 70%, more preferably at least 80% of the length of the application tip.

7. The dispensing container as claimed in claim 1, wherein on its circumferential face, the cap has a circumferential projection which points toward the front end.

8. The dispensing container as claimed in claim 1, wherein on its circumferential face, the cap has a circumferential projection which points toward the rear end.

9. The dispensing container as claimed in claim 8, wherein on its circumferential face, the cap has a plurality of ribs which extend from the rearwardly pointing projection in the direction of the rear end of the cap.

10. A cap for a dispensing container as claimed in claim 1, having an inner face which is adapted to the circumferential face of the application tip wherein a plurality of guide webs are formed on the inner face, and in that, in the plugged-on state, there is a frictional connection between the guide webs of the cap and the circumferential face of the application tip, by way of which frictional connection the cap is held on the application tip.
